(19) United States
(12) Patent Application Publication
(10) Pub. No.: US 2025/0390564 A1
(43) Pub. Date: Dec. 25, 2025

(54) PROCESSING VEHICLE SIGNALS

(71) Applicant: BlackBerry Limited, Waterloo (CA)

(72) Inventor: Pierre Pierre BLAIS, Waterloo (CN)

(21) Appl. No.: 19/235,868

(22) Filed: Jun. 12, 2025

Related U.S. Application Data
(60) Provisional application No. 63/663,933, filed on Jun. 25, 2024.

(51) Int. Cl. G06F 21/31

(52) U.S. Cl. CPC G06F 21/31

(57) ABSTRACT

Systems, methods, and software can be used to control permissions of vehicle signals. In some aspects, one example method includes: receiving a request associated with a vehicle signal; determining, based on a permission value of the vehicle signal, whether an access to an anonymized value of the vehicle signal or an access to a non-anonymized value is authorized; and providing a value of the vehicle signal according to the determining.

### CROSS-REFERENCE TO RELATED APPLICATIONS

This application claims the benefit of priority of U.S. Provisional Patent Application No. 63/663,933, filed on Jun. 25, 2024, which is hereby incorporated by reference in its entirety.

### TECHNICAL FIELD

The present disclosure relates to processing vehicle signals.

### BACKGROUND

A vehicle can include a large number of sensors emitting or generating signals that are constantly reporting state changes in what they are monitoring. These signals can be used to determine the status of different aspects of the vehicle. The vehicle or an entity in the vehicle can further set different values for these signals to control the operation of the vehicle.

### DESCRIPTION OF DRAWINGS

FIG. 1 is a schematic diagram showing an example communication system that controls permissions of vehicle signals, according to an implementation.

FIG. 2 is a flow diagram showing an example method that controls permissions of vehicle signals, according to an implementation.

FIG. 3 is a high-level architecture block diagram of a computing system, according to an implementation.

Like reference numbers and designations in the various drawings indicate like elements.

### DETAILED DESCRIPTION

In some cases, some signals generated by a vehicle can be used to personally identify the user, driver, passenger, owner, or other persons of a vehicle. These signals can be referred to as signals that are associated with personal identifiable information. The information can include identity information related to driver, passenger, or owner of the vehicle, identity information related to the vehicle (e.g., vehicle identification number (VIN), or information related to biometrics of a person related to the vehicle, e.g., fingerprints or images of face or body). The information can also include location information or other sensitive personal information.

In some cases, such information requires additional security protection. For example, legislation requires personal information to be obtained with prior consent. On the other hand, in some cases, other entities may need to use the information in their system for routine operations, e.g., differentiate different drivers.

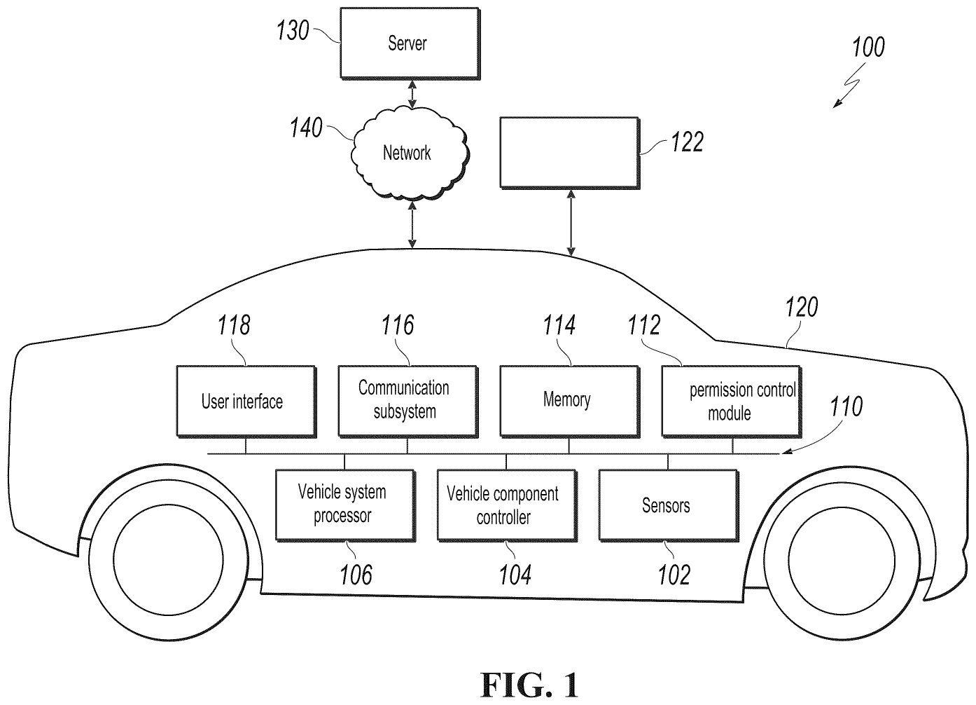

In some implementations, permission regarding anonymized value of the vehicle signal can be defined. When the vehicle receives a request for a value of the signal, the vehicle can check the permission value and determine whether to provide an anonymized value of the vehicle signal or a non-anonymized value of the signal. The approach described in this disclosure provides an efficient way to control the access to personal information associated with the vehicle signals, prevent security breaches, and protect the safety of the vehicle operation. FIGS. 1-3 and associated descriptions provide additional details of these implementations.

FIG. 1 is a schematic diagram showing an example communication system 100 that controls permissions of vehicle signals, according to an implementation. At a high level, the example communication system 100 includes a vehicle 120 that is communicatively coupled with an application 122. The vehicle 120 is also communicatively coupled with a server 130 over a network 140.

The vehicle 120 can be a motor vehicle (e.g., automobile, car, truck, bus, motorcycle, etc.), aircraft (e.g., airplane, unmanned aerial vehicle, unmanned aircraft system, drone, helicopter, etc.), spacecraft (e.g., spaceplane, space shuttle, space capsule, space station, satellite, etc.), watercraft (e.g., ship, boat, hovercraft, submarine, etc.), railed vehicle (e.g., train, tram, etc.), and other types of vehicles including any combinations of any of the foregoing, whether currently existing or after arising. In the illustrated example, the vehicle 120 includes one or more sensors 102, a vehicle component controller 104, a vehicle system processor 106, a communication subsystem 116, a user interface 118, memory 114, and permission control module 112, that are connected to a bus 110.

In some cases, a vehicle can include one or more sensors. The one or more sensors can generate inputs, e.g., video or audio inputs, that reflect the surroundings or environment inside of the vehicle. Examples of the sensors can include cameras, microphones, laser, radar, ultrasonic, light detection and ranging (LIDAR) or any other sensors.

The vehicle 120 includes one or more sensors 102 that detect or measure information for the vehicle 120. Examples of the sensors 102 can include sensors that capture environmental information that is external to the vehicle 120, such as cameras, microphones, laser, radar, ultrasonic, light detection and ranging (LIDAR), and the like. These sensors can provide environmental inputs for an automatic processing platform operating on the vehicle 120 to make automatic decisions. Examples of the sensors 102 can also include devices that capture information that is internal to the vehicle 120, such as monitors for components such as engine, battery, fuel, electronic system, cooling systems, and the like. These sensors can provide operation status and warnings to the automatic processing platform operating on the vehicle 120. Examples of the sensors 102 can also include acoustic sensors that can detect the sound level inside the vehicle 120. The acoustic sensors can determine the noise level inside the vehicle 120 or provide input to other signal processors that determine the noise level.

The vehicle 120 includes a vehicle component controller 104. Although illustrated as a vehicle component controller 104 in FIG. 1, the vehicle 120 can include two or more vehicle component controllers 104. The vehicle component controller 104 represents a controller that controls the operation of a component on the vehicle 120. Examples of the components can include engine, accelerator, brake, radiator, battery, steering wheel, transmission system, cooling system, electrical system, entertainment system, and any other components of the vehicle 120. For example, the vehicle component controller 104 can control the speaker system of the vehicle 120, including controlling the volume, balance, fade, and any other settings for audio output inside the vehicle 120. The vehicle component controller 104 can operate a respective component automatically, according to input from the vehicle system processor 106, or a combination thereof. In some implementations, the vehicle component controller 104 can include a data processing apparatus.

The vehicle system processor 106 can include one or more processing components (alternatively referred to as “processors” or “central processing units” (CPUs)) configured to execute instructions related to one or more of the processes, steps, or actions for the automatic processing platform operating on the vehicle 120. Generally, the vehicle system processor 106 executes instructions and manipulates data to perform the operations of the automatic processing platform. The vehicle system processor 106 can receive inputs from the sensors 102 and generate commands to the vehicle component controller 104. In some cases, the vehicle system processor 106 can perform automatic operations. In some cases, the vehicle system processor 106 can include a data processing apparatus.

The communication subsystem 116 can be configured to provide wireless or wireline communication for data or control information of the vehicle 120. For example, the communication subsystem 116 can support transmissions over wireless local area network (WLAN or WIFI), near field communication (NFC), infrared (IR), Radio-frequency identification (RFID), Bluetooth (BT), Universal Serial Bus (USB), or any other short-range communication protocols. The communication subsystem 116 can also support Global System for Mobile communication (GSM), Interim Standard 95 (IS-95), Universal Mobile Telecommunications System (UMTS), CDMA2000 (Code Division Multiple Access), Evolved Universal Mobile Telecommunications System (E-UMTS), Long Term Evaluation (LTE), LTE-Advanced, fifth-generation (5G), sixth-generation (6G), or any other radio access technologies. The communication subsystem 116 can include, for example, one or more antennas, a receiver, a transmitter, a local oscillator, a mixer, and a digital signal processing (DSP) unit. In some implementations, the communication subsystem 116 can support multiple input multiple output (MIMO) transmissions. In some implementations, the receivers in the communication subsystem 116 can be an advanced receiver or a baseline receiver.

The user interface 118 can include, for example, any of the following: one or more of a display or touch screen display (for example, a liquid crystal display (LCD), a light emitting diode (LED), an organic light emitting diode (OLED), or a micro-electromechanical system (MEMS) display), a keyboard or keypad, a trackball, a speaker, or a microphone. The user interface 118 can also include an I/O interface, for example, a universal serial bus (USB) interface.

The memory 114 can be a computer-readable storage medium. Examples of the memory 114 include volatile and non-volatile memory, magnetic media, optical media, random access memory (RAM), read-only memory (ROM), removable media, and others. The memory 114 can store an operating system (OS) of the vehicle 120 and various other computer-executable software programs for performing one or more of the processes, steps, or actions described above.

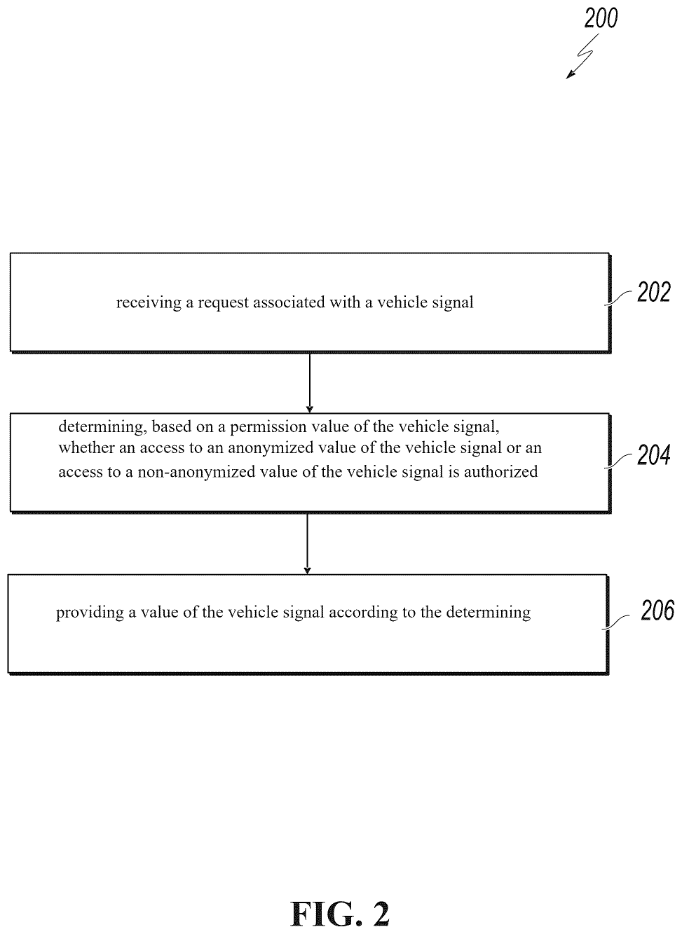

The permission control module 112 represents an application, a set of applications, software, software modules, hardware, or any combination thereof that can be configured to control access permission of the vehicle signals of the vehicle 120. In some implementations, the permission control module 112 can receive a request for vehicle signals, e.g., from application 122. The request can be for read, write, or both. The permission control module 112 determines whether to grant the request based on the permission value of the requested vehicle signal. In some cases, the permission control module 112 determines whether to provide an anonymized value of the vehicle signal or a non-anonymized value based on the permission value of the requested vehicle signal. FIG. 2 and associated descriptions provide additional details of these implementations. In some implementations, the permission control module 112 can be implemented as a separate software program or part of a software program stored in the memory 114 and executed by the vehicle system processor 106.

As illustrated, the bus 110 provides a communication interface for components of the automatic processing platform operating on the vehicle 120. In some cases, the bus 110 can be implemented using a Controller Area Network (CAN) bus.

The application 122 represents an application, a set of applications, software, software modules, hardware, or any combination thereof that request the vehicle signal. In some cases, the application can be executed on an electronic device that connects with the vehicle 120. Such an electronic device may include, without limitation, any of the following: endpoint, computing device, mobile device, mobile electronic device, user device, mobile station, subscriber station, portable electronic device, mobile communications device, wireless modem, wireless terminal, or another electronic device. Examples of an endpoint may include a mobile device, IoT (Internet of Things) device, EoT (Enterprise of Things) device, cellular phone, personal data assistant (PDA), smart phone, laptop, tablet, personal computer (PC), pager, portable computer, portable gaming device, wearable electronic device, health/medical/fitness device, camera, or other mobile communications devices having components for communicating voice or data via a wireless or wired communication network. The electronic device can also be a peripheral device, such as a headset, a remote controller, or a display. The electronic device can connect with the vehicle 120 using short-range communication technology. The short-range communication technology can be wireless, such as BT, NFC, WLAN. The short-range communication technology can also be wired, such as USB.

In some cases, the application 122 can also be installed on the vehicle 120. For example, the application 122 can be a third-party application that controls some operations of the vehicle 120.

The server 130 represents an application, a set of applications, software, software modules, hardware, or any combination thereof that can be configured to manage permission controls of the vehicle 120. In some implementations, the server 130 can receive, store, send, and adjust the permission values of vehicle signals in the vehicle 120, permission values of the application 122, or both.

The example communication system 100 includes the network 140. The network 140 represents an application, set of applications, software, software modules, hardware, or a combination thereof, that can be configured to transmit data between the server 130 and the vehicle 120 in the communication system 100. The network 140 includes a wireless network, a wireline network, or a combination thereof. For example, the network 140 can include one or a plurality of radio access networks (RANs), core networks (CNs), and external networks. The RANs may comprise one or more radio access technologies. In some implementations, the radio access technologies may be Global System for Mobile communication (GSM), Interim Standard 95 (IS-95), Universal Mobile Telecommunications System (UMTS), CDMA2000 (Code Division Multiple Access), Evolved Universal Mobile Telecommunications System (E-UMTS), Long Term Evaluation (LTE), LTE-Advanced, 5G, 6G, or any other radio access technologies. In some instances, the core networks may be evolved packet cores (EPCs).

A RAN is part of a wireless telecommunication system which implements a radio access technology, such as UMTS, CDMA2000, 3GPP LTE, 3GPP LTE-A, and 5G. In many applications, a RAN includes at least one base station. A base station may be a radio base station that may control all or at least some radio-related functions in a fixed part of the system. The base station may provide radio interface within its coverage area or a cell for a mobile device to communicate. The base station may be distributed throughout the cellular network to provide a wide area of coverage. The base station directly communicates to one or a plurality of mobile devices, other base stations, and one or more core network nodes.

While elements of FIG. 1 are shown as including various component parts, portions, or modules that implement the various features and functionality, nevertheless, these elements may, instead, include a number of sub-modules, third-party services, components, libraries, and such, as appropriate. Furthermore, the features and functionality of various components can be combined into fewer components, as appropriate.

FIG. 2 is a flow diagram showing an example method 200 that processing vehicle signals, according to an implementation. The method 200 can be implemented by the entities shown in FIG. 1, including, for example, the vehicle 120, or a component, e.g., a software or hardware or a combination thereof of the vehicle 120. In some cases, the method 200 is implemented by the permission control module 112. The method 200 shown in FIG. 2 can also be implemented using additional, fewer, or different entities. Furthermore, the method 200 shown in FIG. 2 can be implemented using additional, fewer, or different operations, which can be performed in the order shown or in a different order. In some instances, an operation or a group of operations can be iterated or repeated, for example, for a specified number of iterations or until a terminating condition is reached.

At 202, the vehicle receives an access request for a vehicle signal. In some cases, the request can be received from an application, e.g., the application 122 in FIG. 1. The application can execute on an electronic device outside of the vehicle, where the request can be sent by using a wireless or wireline connection, e.g., Bluetooth, NFC, WiFi, LTE, 5G, 6G, USB or any other local or wide area network communication technologies. The application can also execute on the vehicle, e.g., a third-party application that is installed on the operating system of the vehicle.

The vehicle signal can include signals that carry information of the vehicle operations. Examples of the information carried by the vehicle signal include information related to driving operations, e.g., speed, acceleration, location, and etc., information related to entertainment operations, e.g., volumes of audio speakers, information related to cabin operations, e.g., air conditioning (AC) setting, position of the seats, and etc., and any other information related to the operation of the vehicle.

In some cases, the vehicle signal can also include signals related to personal identifiable information (PII). PII refers to information relating to an identified or identifiable natural person, e.g., the driver, the owner, the passenger, or any other persons that are associated with the vehicle. PII is data that can be used to identify, contact, or locate a single person, to identify an individual in context, or to distinguish one person from another. In some cases, PII can be referred to as sensitive personal information (SPI), or personal information. Examples of PII can include information that can be used to distinguish or trace a particular individual's identity, such as name, social security number (SSN), date and place of birth, mother's maiden name, or biometric data such as fingerprint, face, and etc. Examples of PII can also include other information that is linked or linkable to the particular individual, such as medical, educational, financial, and employment information. The PII can include signals representing personal information such as driver's license number, name, home address, Vehicle Identification Number (VIN), insurance information, and etc.

In some cases, Vehicle Signal Specification (VSS) developed by the Connected Vehicle Systems Alliance (COVESA) can be used to define the common format/structure for the vehicle signals. VSS introduces a domain taxonomy for vehicle signals that can be used as standard in automotive applications to communicate information about the vehicle. COVESA can define a catalog of signals. Other catalogs of standards can also be used to define the vehicle signal.

The request at 202 can be an application programming interface (API) request. For example, the vehicle, or an operating system of the vehicle, or other software system of the vehicle may provide API to other applications to interact with the vehicle. The API provides a set of protocols and instructions that can be used by other applications or entities to interact with the vehicle. For example, the API can include different function calls such as get or subscribe. The other applications or entities can use the API function calls to carry out the corresponding tasks. In some cases, the application or entity that sends the request can be referred to as a client.

For example, the API request can be a get request, which can indicate a request to obtain the current value of the vehicle signal. The request can also be a subscribe request, which can indicate a request to provide the client the value of the vehicle signal when the value is updated. The request, e.g., the get request or the subscribe request, can indicate one or more vehicle signals whose values are requested.

In some cases, other API calls can be used to request values of the vehicle signals. In some cases, the request can be in a format that is different from an API call. For example, the request can be formatted according to a standard specification or protocol. In some cases, the request can be a read request that requests to read a particular vehicle signal.

In some cases, the request can also be a request that sets the value of the vehicle signal, e.g., a write request.

At 204, software or hardware on the vehicle determines whether an access to an anonymized value of the vehicle signal or an access to a non-anonymized value of the vehicle signal is authorized. In some implementations, the determination is made based at least in part on a permission value of the vehicle signal.

In some cases, access to APIs can be controlled through permissions. For example, a client may have a permission profile. The permission profile can include permission values for one or more vehicle signals. The permission values can be “read” or “write”, or a combination thereof. For example, if a client has a “read” permission on a vehicle signal. The client is permitted to obtain the value of the vehicle signal. If a client has a “write” permission on a vehicle signal. The client is permitted to set the value of the vehicle signal. If the client does not have either “write” or “read” permission for a vehicle signal, the client cannot obtain or set the value of the signal through the API. In some cases, the permission profile can be set or changed by the manufacturer, the owner, an administrator, system default, or any combinations thereof. In some cases, the permission profile can be generated, provided to the vehicle, or both, when the client registered with the vehicle or a server that manages the operations of the vehicle, e.g., the server 130 in FIG. 1. Therefore, the vehicle (e.g., a software or hardware or a combination thereof on the vehicle, or the permission control module 112) can determine whether to grant the request according to the permission profile of the client. The request can include the vehicle signal and the requested operation. For example, the request is related to a read operation, e.g., a get request or a subscribe request, and the client does not have “read” permission for the vehicle signal in the permission profile, the request will be rejected. On the other hand, the request can be granted and the value of the vehicle signal can be provided if the client has “read” permission for the vehicle signal in the permission profile.

In some cases, as discussed previously, the vehicle signal can be related to PII. Examples of the vehicle signal can include information related to driver identification, passenger identification, vehicle identification, and etc. In these cases, an additional permission value can be used in the permission profile. Instead of simply set the permission to allow the client to read/write or not allow the client to read/write, a permission value can also be used to indicate permissions regarding an anonymized version of the vehicle signal.

In some cases, the data of PII can be anonymized. In some implementations, the anonymized data may still uniquely identify an individual without using personal information. For example, the client may request a value of the Vehicle Identification Number (VIN) of a vehicle. The client may use the VIN in its system to differentiate the vehicle with other vehicles in the system. However, VIN is PII and can be used to obtain sensitive personal information related to the owner of the vehicle. An anonymized version of the VIN can be generated. In one example, the anonymized value of the VIN can be generated by performing a one-way hashing function on the VIN to obtain a hashed value. Examples of the hash function is hash functions in Secure Hash Algorithm 2 (SHA-2), e.g., SHA-256, SHA-512, and etc. Other hash functions or cryptography algorithms can also be used to generate an anonymized value of the VIN. While VIN is used as an example here, anonymized values of other vehicle signals that are related to the identity of the vehicle, identity of the driver (e.g., information on a driver's license such as name, birthday, home address, biometric data and etc.), identity of the passengers (e.g., information obtained through facial or voice recognition), identity of the owner can also be generated using similar algorithms, e.g., processing the value through a hash function.

In this case, the client can use the anonymized value of the signal in its system, e.g., to differentiate from other vehicles or drivers, but may not be able to obtain the actual values of the signal because it may be difficult to reverse process the hash function.

In some cases, a permission value in the permission profile can be set to indicate whether the client is permitted to receive an anonymized value of the vehicle signal instead of the non-anonymized (i.e., actual) value. For example, instead of assigning a “read” permission on VIN to a client, a “read-anonymized” permission can be assigned. This permission can indicate that the client is not permitted to receive the actual value of the VIN but is permitted to receive the anonymized value of the VIN.

Accordingly, when the vehicle receives the request of a vehicle signal, the vehicle can check the permission value of the vehicle signal in the client's permission profile to determine whether the client has access to the anonymized value of the vehicle signal, a non-anonymized value of the vehicle signal, or neither. If the permission value indicates “read-anonymized”, the vehicle can provide the anonymized value of the signal based on the type of the request (e.g., providing current value if the request is a get request, or providing the value when the value is changed or updated if the request is a subscribe request). If the permission value indicates “read”, the vehicle can provide the non-anonymized value of the signal. If the permission value indicates neither is permitted, then the request is rejected and neither anonymized value nor non-anonymized value is provided. In some cases, instead of using “read” to indicate a permission of access to the non-anonymized value, a “read-non-anonymized” permission can be defined to indicate a permission of access to the non-anonymized value.

In some cases, the request can also include the information of the requested application, e.g., an identifier of the client. In these or other cases, the vehicle can search the permission profile of the client based on the identifier of the client and obtain the permission value of the vehicle signal for the client. In some cases, the request can also include the permission(s) the client has been assigned to.

In some cases, the permission profile can be obtained by the vehicle when the client connects to the vehicle and sends the permission profile to the vehicle. Alternatively, or in combination, the vehicle can obtain the permission profile from a server that manages the vehicle. In some cases, the permission profile can include authentication signatures obtained through authentication procedures. The authentication signatures can be validated by the vehicle when the vehicle receives the permission profile. In some cases, default permission values for a set of vehicle signals can be defined or configured by the manufacturer, and the default permission values can be updated by the operation administrator of the vehicle, the owner of the vehicle, the driver or operator of the vehicle, or others. The updates can be performed by using or modifying the permission profile.

In some cases, the permission value can be updated before the request is received, e.g., through user consent procedures when the vehicle is activated.

In some cases, the permission value in the permission profile can also be set or updated in response to the request. For example, the vehicle can determine that the vehicle signal in the request has an anonymized value in additional to the actual value, the vehicle can output a user interface object on a user interface of the vehicle. The user interface object can indicate a request of a user input on whether to provide an anonymized value of the vehicle signal or a non-anonymized value. Examples of the user interface object can be an icon, a dialogue box, or other visual or audio output. The user interface object can include options representing different permission values, including e.g., providing actual value, providing anonymized value, providing neither value, or any combinations thereof. The user interface can also output other information, including e.g., information related to the identity of the client (including an application type of the client, a user of the client), information related to the vehicle signal, default permission value, security risks, and etc. The user interface can receive user input indicating the selected permission value. The user input can include a touch, a tap, a swipe, or any other gestures or audio input. The vehicle can use the selected permission value to determine whether to provide the non-anonymized value or the anonymized value or neither to the client. The vehicle can also use the selected permission value to set/update the permission value in the permission profile.

In some cases, additional API requests can be defined to request anonymized values of a vehicle signal. For example, in addition to a get request or a subscribe request, a “getAnonymized” request or a “subscribeAnonymized” can be defined in the API. Accordingly, a client can use the “getAnonymized” request or the “subscribeAnonymized” to request anonymized value of the request. In some cases, a default permission can be defined to always allow access to anonymized values of the signal.

If the anonymized versions of API requests are defined in the API, then a regular get request or subscribe request can be interpreted as a request for non-anonymized value for the signal. Such a request can be rejected if the client does not have permission to access the non-anonymized value for the signal.

Alternatively, or in combination, the current version of the API request, e.g., the get request or the subscribe request, can be interpreted as a request for either anonymized value or non-anonymized value of the signal. The vehicle can check the permission value of the signal for the client and determine whether to provide the anonymized value or non-anonymized value according to the permission value. This approach can reduce the number of API functions and simplify implementations of the client.

At 206, the vehicle provides the value of the vehicle signal according to at least the determination process at step 204 related to the permission value in the client's permission profile. For example, as discussed previously, if the permission value indicates “read-anonymized”, the vehicle can provide the anonymized value of the signal based on the type of the request (e.g., providing current value if the request is a get request, or providing the value when the value is changed or updated if the request is a subscribe request). If the permission value indicates “read”, the vehicle can provide the non-anonymized value of the signal. If the permission value indicates neither is permitted, then the request is rejected and neither anonymized value nor non-anonymized value is provided.

In some cases, the vehicle can send additional information to the client in a response. For example, the additional information can indicate that the value provided is anonymized value of the request signal. The additional information can also indicate the permission value of the signal for the client according to the permission profile, or default setting, or a combination thereof.

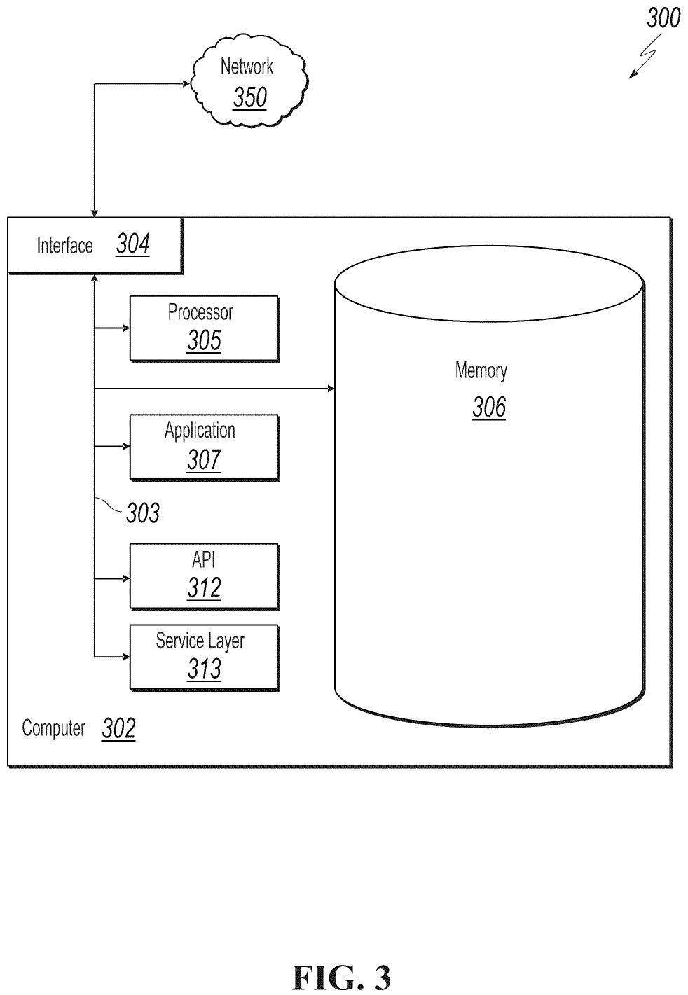

FIG. 3 is a high-level architecture block diagram showing a computer 302 coupled with a network 350, according to an implementation. The described illustration is only one possible implementation of the described subject matter and is not intended to limit the disclosure to the single described implementation. Those of ordinary skill in the art will appreciate the fact that the described components can be connected, combined, or used in alternative ways, consistent with this disclosure.

The network 350 facilitates communications between the computer 302 and other devices. In some cases, a user, e.g., an administrator, can access the computer 302 from a remote network. In these or other cases, the network 350 can be a wireless or a wireline network. In some cases, a user can access the computer 302 locally. In these or other cases, the network 350 can also be a memory pipe, a hardware connection, or any internal or external communication paths between the components.

The computer 302 includes a computing system configured to perform the algorithm described in this disclosure. For example, the computer 302 can be used to implement the server 130 shown in FIG. 1. The computer 302 can be used to implement an electronic device that runs the application 122 shown in FIG. 1, e.g., as a laptop computer or a smart phone. The computer 302 can also be used to implement the permission control module 112 shown in FIG. 1. In some cases, the algorithm can be implemented in an executable computing code, e.g., C/C++ executable code. Alternatively, or in combination, the algorithm can be implemented in an application program, e.g., EXCEL. In some cases, the computer 302 can include a standalone LINUX system that runs batch applications. In some cases, the computer 302 can include mobile or personal computers that run the application program.

The computer 302 may include an input device, such as a keypad, keyboard, touch screen, microphone, speech recognition device, or another device that can accept user information, and/or an output device that conveys information associated with the operation of the computer 302, including digital data, visual and/or audio information, or a GUI.

The computer 302 can serve as a client, network component, a server, a database or other persistency, or the like. In some implementations, one or more components of the computer 302 may be configured to operate within a cloud-computing-based environment.

At a high level, the computer 302 is an electronic computing device operable to receive, transmit, process, store, or manage data and information. According to some implementations, the computer 302 may also include or be communicably coupled with an application server, e-mail server, web server, caching server, streaming data server, business intelligence (BI) server, and/or other server.

The computer 302 can receive requests over network 350 from a client application (e.g., executing on a user device) and respond to the received requests by processing said requests in an appropriate software application. In addition, requests may also be sent to the computer 302 from internal users (e.g., from a command console or by another appropriate access method), external or third parties, other automated applications, as well as any other appropriate entities, individuals, systems, or computers.

Each of the components of the computer 302 can communicate using a system bus 303. In some implementations, any and/or all the components of the computer 302, both hardware and/or software, may interface with each other and/or the interface 304 over the system bus 303, using an application programming interface (API) 312 and/or a service layer 313. The API 312 may include specifications for routines, data structures, and object classes. The API 312 may be either computer language-independent or-dependent and refer to a complete interface, a single function, or even a set of APIs. The service layer 313 provides software services to the computer 302. The functionality of the computer 302 may be accessible for all service consumers using this service layer. Software services, such as those provided by the service layer 313, provide reusable, defined business functionalities through a defined interface. For example, the interface may be software written in JAVA, C++, or other suitable language providing data in Extensible Markup Language (XML) format or another suitable format. While illustrated as an integrated component of the computer 302, alternative implementations may illustrate the API 312 and/or the service layer 313 as stand-alone components in relation to other components of the computer 302. Moreover, any or all parts of the API 312 and/or the service layer 313 may be implemented as child or sub-modules of another software module or hardware module, without departing from the scope of this disclosure.

The computer 302 includes an interface 304. Although illustrated as a single interface 304 in FIG. 3, two or more interfaces 304 may be used according to particular needs, configurations, or particular implementations of the computer 302. The interface 304 is used by the computer 302 for communicating with other systems in a distributed environment connected to the network 350 (whether illustrated or not). Generally, the interface 304 comprises logic encoded in software and/or hardware in a suitable combination and operable to communicate with the network 350. More specifically, the interface 304 may comprise software supporting one or more communication protocols associated with communications such that the network 350 or the interface's hardware are operable to communicate physical signals.

The computer 302 includes a processor 305. Although illustrated as a single processor 305 in FIG. 3, two or more processors may be used according to particular needs, configurations, or particular implementations of the computer 302. Generally, the processor 305 executes instructions and manipulates data to perform the operations of the computer 302. In some cases, the processor 305 can include a data processing apparatus.

The computer 302 also includes a memory 306 that holds data for the computer 302. Although illustrated as a single memory 306 in FIG. 3, two or more memories may be used according to particular needs, configurations, or particular implementations of the computer 302. While memory 306 is illustrated as an integral component of the computer 302, in alternative implementations, memory 306 can be external to the computer 302.

The application 307 comprises an algorithmic software engine providing functionality according to particular needs, configurations, or particular implementations of the computer 302. Although illustrated as a single application 307, the application 307 may be implemented as multiple applications 307 on the computer 302. In addition, although illustrated as integral to the computer 302, in alternative implementations, the application 307 can be external to the computer 302.

There may be any number of computers 302 associated with, or external to, the system 300 and communicating over network 350. Further, the terms “client,” “user,” and other appropriate terminology may be used interchangeably, as appropriate, without departing from the scope of this disclosure. Moreover, this disclosure contemplates that many users may use one computer 302, or that one user may use multiple computers 302.

Described implementations of the subject matter can include one or more features, alone or in combination.

For example, in a first implementation, a method, comprising: receiving a request associated with a vehicle signal; determining, based on a permission value of the vehicle signal, whether an access to an anonymized value of the vehicle signal or an access to a non-anonymized value of the vehicle signal is authorized; and providing a value of the vehicle signal according to the determining.

The foregoing and other described implementations can each, optionally, include one or more of the following features:

A first feature, combinable with any of the following features, wherein the vehicle signal comprises personal identifiable information (PII).

A second feature, combinable with any of the previous or following features, wherein the request is an application programming interface (API) request.

A third feature, combinable with any of the previous or following features, wherein the request is a get request or a subscribe request.

A fourth feature, combinable with any of the previous or following features, wherein the determining is performed based on a permission profile.

A fifth feature, combinable with any of the previous or following features, wherein the permission value comprises at least one of a first permission value associated with a read operation of the vehicle signal or a second permission value associated with a read-anonymized operation of the vehicle signal.

A sixth feature, combinable with any of the previous features, further comprising outputting a user interface object to request a user input on whether to provide an anonymized value of the vehicle signal or a non-anonymized value of the vehicle signal.

In a second implementation, a computing device, comprising: at least one hardware processor; and one or more computer-readable storage media coupled to the at least one hardware processor and storing programming instructions for execution by the at least one hardware processor, wherein the programming instructions, when executed, cause the computing device to perform operations comprising: receiving a request associated with a vehicle signal; determining, based on a permission value of the vehicle signal, whether an access to an anonymized value of the vehicle signal or an access to a non-anonymized value of the vehicle signal is authorized; and providing a value of the vehicle signal according to the determining.

The foregoing and other described implementations can each, optionally, include one or more of the following features:

A first feature, combinable with any of the following features, wherein the vehicle signal comprises personal identifiable information (PII).

A second feature, combinable with any of the previous or following features, wherein the request is an application programming interface (API) request.

A third feature, combinable with any of the previous or following features, wherein the request is a get request or a subscribe request.

A fourth feature, combinable with any of the previous or following features, wherein the determining is performed based on a permission profile.

A fifth feature, combinable with any of the previous or following features, wherein the permission value comprises at least one of a first permission value associated with a read operation of the vehicle signal or a second permission value associated with a read-anonymized operation of the vehicle signal.

A sixth feature, combinable with any of the previous features, the operations further comprising outputting a user interface object to request a user input on whether to provide an anonymized value of the vehicle signal or a non-anonymized value of the vehicle signal.

In a third implementation, a computer-readable medium storing instructions which, when executed, cause a computing device to perform operations comprising: receiving a request associated with a vehicle signal; determining, based on a permission value of the vehicle signal, whether an access to an anonymized value of the vehicle signal or an access to a non-anonymized value of the vehicle signal is authorized; and providing a value of the vehicle signal according to the determining.

The foregoing and other described implementations can each, optionally, include one or more of the following features:

A first feature, combinable with any of the following features, wherein the vehicle signal comprises personal identifiable information (PII).

A second feature, combinable with any of the previous or following features, wherein the request is an application programming interface (API) request.

A third feature, combinable with any of the previous or following features, wherein the request is a get request or a subscribe request.

A fourth feature, combinable with any of the previous or following features, wherein the determining is performed based on a permission profile.

A fifth feature, combinable with any of the previous or following features, wherein the permission value comprises at least one of a first permission value associated with a read operation of the vehicle signal or a second permission value associated with a read-anonymized operation of the vehicle signal.

A sixth feature, combinable with any of the previous features, the operations further comprising outputting a user interface object to request a user input on whether to provide an anonymized value of the vehicle signal or a non-anonymized value of the vehicle signal.

Some of the subject matter and operations described in this disclosure can be implemented in digital electronic circuitry, or in computer software, firmware, or hardware, including the structures described in this disclosure and their structural equivalents, or in combinations of one or more of them. Some of the subject matter described in this disclosure can be implemented as one or more computer programs, i.e., one or more modules of computer program instructions, encoded on a computer storage medium for execution by, or to control the operation of, data-processing apparatus. Alternatively, or in addition, the program instructions can be encoded on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or any combinations of computer-storage mediums.

The terms “data-processing apparatus,” “computer,” or “electronic computer device” encompass all kinds of apparatus, devices, and machines for processing data, including, by way of example, a programmable processor, a computer, a system on a chip, or multiple ones, or combinations of the foregoing. The apparatus can include special purpose logic circuitry, e.g., an FPGA (field programmable gate array) or an ASIC (application specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable, conventional operating system.

A computer program, which may also be referred to, or described, as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may, instead, include a number of sub-modules, third-party services, components, libraries, and such, as appropriate. Conversely, the features and functionality of various components can be combined into single components, as appropriate.

Some of the processes and logic flows described in this disclosure can be performed by one or more programmable processors, executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read-only memory or a random-access memory, or both. A processor can include, by way of example, a programmable processor, a computer, a system on a chip, or multiple ones, or combinations of the foregoing. A processor can include special purpose logic circuitry, e.g., a CPU (central processing unit), an FPGA (field programmable gate array) or an ASIC (application specific integrated circuit).

Computers suitable for the execution of a computer program can be based on general or special purpose microprocessors, both, or any other kind of CPU. Generally, a CPU will receive instructions and data from a read-only memory (ROM) or a random-access memory (RAM), or both. The essential elements of a computer are a CPU, for performing or executing instructions, and one or more memory devices, for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including, by way of example, semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry. In some cases, the computer storage medium can be transitory, non-transitory, or a combination thereof.

To provide for interaction with a user, implementations of the subject matter described in this disclosure can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to, and receiving documents from, a device that is used by the user, for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 millisecond (ms), less than 1 sec., less than 5 secs., etc. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Implementations of the subject matter described in this disclosure can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this disclosure, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system, or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, either hardware or software (or a combination of hardware and software), may interface with each other, or the interface using an application programming interface (API), or a service layer (or a combination of API and service layer). The API may include specifications for routines, data structures, and object classes. The API may be either computer language, independent or dependent, and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in extensible markup language (XML) format or another suitable format. The API or service layer (or a combination of the API and the service layer) may be an integral or a stand-alone component in relation to other components of the computing system. Moreover, any or all parts of the service layer may be implemented as child or sub-modules of another software module, or hardware module without departing from the scope of this disclosure.

While this disclosure contains many specific implementation details, these should not be construed as limitations on the scope of any invention or on the scope of what may be claimed, but rather as descriptions of features that may be specific to particular implementations of particular inventions. Certain features that are described in this disclosure in the context of separate implementations can also be implemented, in combination, in a single implementation. Conversely, various features that are described in the context of a single implementation can also be implemented in multiple implementations, separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described above should not be understood as requiring such separation or integration in all implementations, and it should be understood that the described program components and systems can, generally, be integrated together in a single software product or packaged into multiple software products.

Accordingly, the above description of example implementations does not define or constrain this disclosure. Other changes, substitutions, and alterations are also possible without departing from the spirit and scope of this disclosure.

Furthermore, any claimed implementation below is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the computer-readable medium.

1. A method, comprising:
receiving a request associated with a vehicle signal;
determining, based on a permission value of the vehicle signal, whether an access to an anonymized value of the vehicle signal or an access to a non-anonymized value of the vehicle signal is authorized; and
providing a value of the vehicle signal according to the determining.

2. The method of claim 1, wherein the vehicle signal comprises personal identifiable information (PII).

3. The method of claim 1, wherein the request is an application programming interface (API) request.

4. The method of claim 1, wherein the request is a get request or a subscribe request.

5. The method of claim 1, wherein the determining is performed based on a permission profile.

6. The method of claim 1, wherein the permission value comprises at least one of a first permission value associated with a read operation of the vehicle signal or a second permission value associated with a read-anonymized operation of the vehicle signal.

7. The method of claim 1, further comprising: outputting a user interface object to request a user input on whether to provide an anonymized value of the vehicle signal or a non-anonymized value of the vehicle signal.

8. A computing device, comprising:
at least one hardware processor; and
one or more computer-readable storage media coupled to the at least one hardware processor and storing programming instructions for execution by the at least one hardware processor, wherein the programming instructions, when executed, cause the computing device to perform operations comprising:
receiving a request associated with a vehicle signal;
determining, based on a permission value of the vehicle signal, whether an access to an anonymized value of the vehicle signal or an access to a non-anonymized value of the vehicle signal is authorized; and
providing a value of the vehicle signal according to the determining.

9. The computing device of claim 8, wherein the vehicle signal comprises personal identifiable information (PII).

10. The computing device of claim 8, wherein the request is an application programming interface (API) request.

11. The computing device of claim 8, wherein the request is a get request or a subscribe request.

12. The computing device of claim 8, wherein the determining is performed based on a permission profile.

13. The computing device of claim 8, wherein the permission value comprises at least one of a first permission value associated with a read operation of the vehicle signal or a second permission value associated with a read-anonymized operation of the vehicle signal.

14. The computing device of claim 8, the operations further comprising:
outputting a user interface object to request a user input on whether to provide an anonymized value of the vehicle signal or a non-anonymized value of the vehicle signal.

15. A computer-readable medium storing instructions which, when executed, cause a computing device to perform operations comprising:
receiving a request associated with a vehicle signal;
determining, based on a permission value of the vehicle signal, whether an access to an anonymized value of the vehicle signal or an access to a non-anonymized value of the vehicle signal is authorized; and
providing a value of the vehicle signal according to the determining.

16. The computer-readable medium of claim 15, wherein the vehicle signal comprises personal identifiable information (PII).

17. The computer-readable medium of claim 15, wherein the request is an application programming interface (API) request.

18. The computer-readable medium of claim 15, wherein the request is a get request or a subscribe request.

19. The computer-readable medium of claim 15, wherein the determining is performed based on a permission profile.

20. The computer-readable medium of claim 15, wherein the permission value comprises at least one of a first permission value associated with a read operation of the vehicle signal or a second permission value associated with a read-anonymized operation of the vehicle signal.
